(19) United States
(12) Patent Application Publication
(10) Pub. No.: US 2005/0177523 A1
(43) Pub. Date: Aug. 11, 2005

(54) Method for improving the terms of consumer relationships

(76) Inventors: Jeffrey Weiss, Potomac, MD (US); Gerson S. Panitch, Potomac, MD (US)

Correspondence Address: WEISS & MOY PC, 4204 NORTH BROWN AVENUE, SCOTTSDALE, AZ, 85251, US

(21) Appl. No.: 11/024,304

(22) Filed: Dec. 28, 2004

Related U.S. Application Data
(60) Provisional application No. 60/532,868, filed on Dec. 29, 2003.

(51) Int. Cl. H04L 9/32

(52) U.S. Cl. 705/80

(57) ABSTRACT

A method for providing consumers with alternatives to existing consumer relationships. A service may prompt a consumer to provide information about first existing terms of a first existing relationship between the consumer and a first provider and to provide information about second existing terms of a second existing relationship between the consumer and a second provider. The service may then enable a determination about whether another provider is willing to provide to the consumer first alternate terms that are more favorable than the first existing terms and about whether another provider is willing to provide to the consumer second alternate terms that are more favorable than the second existing terms. The service may, when another provider is willing to provide the consumer with the more favorable first alternate terms, enabling the presentation to the consumer of an offer based on the first alternate terms. The service may also, when another provider is willing to provide the consumer with the more favorable second alternate terms, enabling the presentation to the consumer of an offer based on the second alternate terms.

### RELATED APPLICATION

This non-provisional application claims priority from provisional application No. 60/532,868, filed on Dec. 29, 2003.

### TECHNICAL FIELD

Aspects of this invention relate generally to matching a consumer desirous of improving the terms of existing financial, contractual, or habitual relationships with providers able to provide terms perceived to be more favorable by the consumer.

### BACKGROUND

Consumers are typically parties to certain extended term or extended payment financial relationships. These may include mortgages, car loans, credit card agreements, wireless phone service contracts, long-distance phone service contracts, internet service provider agreements and other agreement for goods and/or services. In addition, even when there is no contract in place, by force of habit, consumers tend to continue existing relationships.

Regardless of the type of relationship, they often share several commonalities. They typically involve payments by the consumer over an extended period of time. In many instances, they can be supplanted by other providers who might extend terms perceived as more advantageous to the consumer. However a lack of information about the existence of better terms, or the effort it takes for the consumer to identify an alternative provider, might hamper the consumer's ability to obtain more favorable terms.

For example, a homeowner whose mortgage requires the payment of interest at a rate that is sufficiently higher than the prevailing interest rate may find it advantageous to re-finance at a lower interest rate, or in exchange for a longer payout term. Car loans and the like could be re-financed in similar fashion. Similarly, consumers are often able to improve on the interest rate charged by their existing credit card providers. Still further, a wireless phone customer may be able to acquire from another provider more minutes, or the same amount of minutes for a lower monthly rate. Yet, in the above examples, the barrier to switching often keeps consumers paying rates less favorable than what might be available through an alternate provider. To take advantage of more advantageous opportunities, a consumer must know about opportunities and understand them. That may require time, sophistication, or even special commercial relationships that the consumer does not possess.

On the other hand, a service provider wishing to alert a consumer to such an opportunity may be limited by a lack of knowledge of the consumer's current agreement terms, and/or by restrictions on telemarketing, spam e-mail, or like activities.

### BRIEF DESCRIPTION

In accordance with one inventive embodiment, there may be provided a method for presenting consumers with alternatives to existing consumer relationships. This embodiment may include, for example: prompting a consumer to provide information about first existing terms of a first existing relationship between the consumer and a first provider; prompting the consumer to provide information about second existing terms of a second existing relationship between the consumer and a second provider; enabling a determination about whether another provider is willing to provide to the consumer first alternate terms that are more favorable than the first existing terms; enabling a determination about whether another provider is willing to provide to the consumer second alternate terms that are more favorable than the second existing terms; when another provider is willing to provide the consumer with the more favorable first alternate terms, enabling the presentation to the consumer of an offer based on the first alternate terms; and when another provider is willing to provide the consumer with the more favorable second alternate terms, enabling the presentation to the consumer of an offer based on the second alternate terms.

In accordance with another inventive embodiment, there may be provided a method for presenting consumers with alternatives to existing consumer relationships. This embodiment may include, for example: prompting a consumer to provide information about first existing terms of a first existing relationship between the consumer and a first provider; wherein the first existing relationship involves one of a mortgage, car loan, wired or wireless telephone service, data transmission service, credit card service, dry cleaning service, cable or satellite television service, yard service, pool service, Internet service, maid service, snow removal service, magazine subscription, utilities, phone service, multi-media delivery, motion picture rentals and broadcasting; advertising opportunities in broadcast and print; waste removal service; landscaping service, video delivery, food delivery; gasoline purchasing; heating oil; transportation service, auto service (maintenance or repair); insurance; service contract on appliances, extended warranty contracts; real estate and automobiles; prompting the consumer to provide information about second existing terms of a second existing relationship between the consumer and a second provider; wherein the second existing consumer relationship involves a different one of a involves one of a mortgage, car loan, wired or wireless telephone service, data transmission service, credit card service, dry cleaning service, cable or satellite television service, yard service, pool service, Internet service, maid service, snow removal service, magazine subscription, utilities, phone service, multi-media delivery, motion picture rentals and broadcasting; advertising opportunities in broadcast and print; waste removal service; landscaping service, video delivery, food delivery; gasoline purchasing; heating oil; transportation service, auto service (maintenance or repair), insurance; service contract on appliances, extended warranty contracts; real estate and automobiles; enabling a determination about whether another provider is willing to provide to the consumer first alternate terms that are more favorable than the first existing terms; enabling a determination about whether another provider is willing to provide to the consumer second alternate terms that are more favorable than the second existing terms; when another provider is willing to provide the consumer with the more favorable first alternate terms, enabling the presentation to the consumer of an offer based on the first alternate terms; when another provider is willing to provide the consumer with the more favorable second alternate terms, enabling the presentation to the consumer of an offer based on the second alternate terms; and enabling the acceptance by the consumer of the offer based on the first alternate terms.

In accordance with still another inventive embodiment, there may be provided a method for presenting consumers with alternatives to existing consumer relationships. This embodiment may include, for example: prompting a consumer to provide information about first existing terms of a first existing relationship between the consumer and a first provider; wherein the first existing relationship involves one of a mortgage, car loan, wired or wireless telephone service, data transmission service, credit card service, dry cleaning service, cable or satellite television service, yard service, pool service, Internet service, maid service, snow removal service, magazine subscription, utilities, phone service, multi-media delivery, motion picture rentals and broadcasting; advertising opportunities in broadcast and print; waste removal service; landscaping service, video delivery, food delivery; gasoline purchasing; heating oil; transportation service, auto service (maintenance or repair); insurance; service contract on appliances, extended warranty contracts; real estate and automobiles; prompting the consumer to provide information about second existing terms of a second existing relationship between the consumer and a second provider; wherein the second existing consumer relationship involves a different one of a mortgage, car loan, wired or wireless telephone service, data transmission service, credit card service, dry cleaning service, cable or satellite television service, yard service, pool service, Internet service, maid service, snow removal service, magazine subscription, utilities, phone service, multi-media delivery, motion picture rentals and broadcasting; advertising opportunities in broadcast and print; waste removal service; landscaping service, video delivery, food delivery; gasoline purchasing; heating oil; transportation service, auto service (maintenance or repair), insurance; service contract on appliances, extended warranty contracts; real estate and automobiles; enabling at least one potential alternate provider to view at least one of the first existing terms and the second existing terms; enabling a determination about whether another provider is willing to provide to the consumer first alternate terms that are more favorable than the first existing terms; enabling a determination about whether another provider is willing to provide to the consumer second alternate terms that are more favorable than the second existing terms; when another provider is willing to provide the consumer with the more favorable first alternate terms, enabling the presentation to the consumer of an offer based on the first alternate terms; when another provider is willing to provide the consumer with the more favorable second alternate terms, enabling the presentation to the consumer of an offer based on the second alternate terms; and enabling the acceptance by the consumer of the offer based on the first alternate terms.

### BRIEF DESCRIPTION OF THE DRAWINGS

FIG. 1 is a flow chart, illustrating a method for providing consumers with alternatives to existing consumer relationships consistent with an embodiment of the present invention.

FIG. 2 is a flow chart, illustrating a method for providing consumers with alternatives to existing consumer relationships consistent with an embodiment of the present invention.

### DETAILED DESCRIPTION OF EXEMPLARY PREFERRED EMBODIMENTS

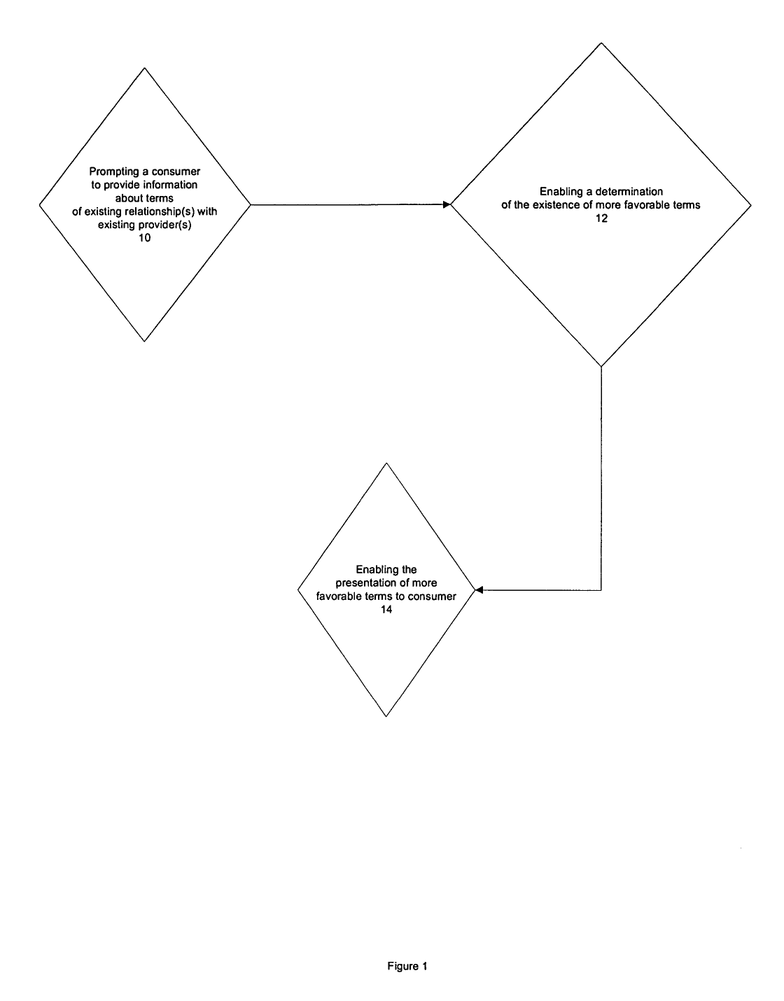

In one inventive embodiment, illustrated in FIG. 1, a method may involve prompting a consumer to provide information about first existing terms of a first existing relationship between the consumer and first provider (10). As used herein, the term “consumer” may refer to one or more of an individual, family, group, partnership, corporation, business, or any other entity that may consume goods or services. A “consumer relationship” may broadly encompass any relationship by which a consumer provides consideration for goods or services, as well as any loan relationship to which a consumer is a party, and the like. The relationship may be pursuant to a contract, habit, or otherwise. By way of non-limiting examples, consumer relationships may involve mortgages, car loans, wired or wireless telephone services, data transmission services, credit card services, dry cleaning services, cable or satellite television services, yard services, pool services, Internet services, maid services, snow removal services, magazine subscriptions, utilities, phone service, multi-media delivery, motion picture rentals and broadcasting; advertising opportunities in broadcast and print; waste removal services; landscaping services, video delivery, food delivery; gasoline purchasing; heating oil; transportation services, auto services (maintenance and repair), auto insurance, life insurance; health insurance; service contracts on appliances, extended warranty contracts; real estate and automobiles, and any other type of relationship wherein competition might provide the consumer with an opportunity for better terms.

A “provider” may likewise be any individual, partnership, group, business, corporation or other entity that supplies goods or services to the consumer. Thus, in a home mortgage example, a consumer may be a home owner and the provider may be a mortgage broker or lender. Or the provider might be an agent or third party who acts on behalf of the mortgage broker or lender.

As mentioned previously, a relationship between a consumer and a provider may be by contract, habit, or otherwise. In a mortgage or insurance relationship, there is typically a contract between the consumer and the provider. In other relationships such as the relationship that exists between a consumer and a gas station, laundry service, or yard service, there may or may not be a formal agreement. The consumer often continues the relationship by force of habit.

“Existing terms of a relationship” between the consumer and the provider may include one or more details about what the consumer conveys to the provider and/or what the provider conveys to the consumer in return, as part of the relationship. For a loan, such information may include, for example, the principal amount owed, rate of interest and term of payment. For a credit card, such information may include, for example, a rate of interest. For a relationship pursuant to which the consumer purchases goods or services, such information may include a price of the goods or services received by the consumer in exchange for such price.

Consistent with the invention, the consumer might be prompted to provide information about the terms of an existing relationship. “Prompting” might occur in any one of myriad ways. Prompting can occur through printed or broadcast advertisements encouraging the consumer to provide information about existing relationships using, for example, a network such as the Internet, a phone network, a data network, by transmitting information in hard copy through parcel post, or any other mechanism for seeking information from the consumer. Alternately, a consumer may be prompted by face-to-face interaction, such as through live solicitation in a public place. In accordance with the invention, it is contemplated that prompting may occur directly or indirectly. For example, a web site host may be said to prompt a consumer by directly posting a question to the consumer on the web site. One who hires another to post a question, or who engages in an agency relationship to cause another to seek information from a consumer is also said to “prompt the consumer to provide information . . . ” in accordance with the invention, even though that prompting may be considered indirect.

The Internet may be used in various ways as a platform for prompting a consumer. For example, as previously mentioned, a website might prompt a consumer to input information about various existing relationships the consumer has with existing providers. E-mail advertisements might be used to prompt and/or pop-up advertising might be used.

Thus, in a mortgage context, the consumer might be prompted in some fashion to provide one or more of an existing interest rate, loan amount, and financing terms on web site. In a credit card context, the consumer might be prompted to enter one or more of an amount of credit card debt, minimum monthly payment, interest rate, or any other financial term. In the cellular phone context, a consumer might be prompted to provide one or more of the name of an existing service provider, remaining time on contract, included monthly minutes, cost, or any other term of the consumer's existing plan. For relationships where there is no contract, the consumer might be prompted to provide information on what the consumer is accustomed to paying. For example, a consumer in the habit of paying a certain price for goods such as gasoline or home heating oil might be prompted to identify a geographical area, grade of fuel, and typical price.

As an alternative to prompting through computer networks interactive voice response systems or data messaging might be used to prompt a consumer to provide information about existing relationships.

The prompting might include providing a mechanism for the consumer to enter information about more than one existing relationship. In the web site example, a pick list might be provided to enable the consumer to enter information about various existing relationships. In this way, the consumer might visit a single trusted location at which the consumer can enter information about multiple relationships. The relationships need not be in categories related to each other. In other words, the consumer might be prompted to provide information about relationships that the consumer would not expect to be handled by a single provider. Thus, for example, the same mechanism used to prompt the consumer for information about existing mortgage terms might also prompt the consumer for information about existing cellular telephone terms. Thus, one trusted intermediary might serve as a consolidated broker for multiple goods/services providers. While an embodiment of the invention contemplates that the prompting might be performed by an intermediary, this need not be the case. The trusted broker might itself provide some or all of the goods/services.

As part of the prompting process or separate therefrom, the consumer may be asked to identify possible alternate terms that it may be seeking. The consumer may also or in the alternative be asked to identify one or more minimum terms that the consumer would wish to see satisfied and/or exceeded in any offer presented hereunder from an alternate provider. One or more of these alternatives may be utilized to provide a consumer with comfort that he or she will not be contacted with offers based on alternate terms that the consumer may not regard as sufficiently improved to merit acceptance of such an offer.

For ease of discussion, the invention is described in connection with first and second existing providers. However, such nomenclature is not intended to limit such embodiments to only first and second existing providers. Rather, it is contemplated that the consumer might be prompted to provide information about one or more additional existing relationships.

In one exemplary embodiment, it may be further desired to have the consumer provide identifying information, such as a name, address, account number, credit card number, driver's license number, social security number, or the like, so that the consumer's identity may be verified. Indeed, it may be possible to utilize certain consumer-provided information, such as an account number with an existing provider, to access information concerning terms of one or more of a consumer's existing relationships, so that the consumer will not be required to provide such information. Thus, in an alternative embodiment of the invention, “prompting the consumer to provide information about an existing relationship” might include having the consumer simply provide information sufficient to identify an existing relationship, thereby permitting an intermediary, existing provider, and/or a potential alternate provider look-up the customer's existing terms.

To alleviate privacy concerns, one embodiment of the invention may permit the consumer to enter information anonymously, or quasi-anonymously. For example, the consumer might only be prompted to provide identifying information after there is a better offer to extend to the consumer. At that point, the consumer might be advised that a better offer exists and that the consumer will be notified of the alternate terms after more specific identifying information is provided by the consumer.

As previously mentioned, the method may be adapted to permit a consumer to provide information concerning a plurality of consumer relationships, including for example any number of the possible consumer relationships listed by way of example above. In an alternate embodiment, it may be desired to focus on only a particular type of consumer relationship, such as (by way of example only) insurance services, home or auto repair services, or cellular phone services. An embodiment of the invention may prompt a consumer to provide information concerning at least two different consumer relationships (e.g., related categories such as health insurance and auto insurance; or unrelated categories such as home mortgage and wireless telephone services).

Referring to Step 12 of FIG. 1, an exemplary embodiment may involve enabling a determination about whether another provider is willing to provide to the consumer alternate terms that are more favorable than the existing terms. In accordance with the invention, enabling such a determination may occur in a myriad of ways. The entity that received the information from the consumer (or an agent or employee thereof) might compare the consumer's information with alternate terms available through the entity or through another cooperating with that entity. Enabling a determination in this context might include maintaining a database of alternative terms so that the determination may be made.

Or enabling a determination might alternately involve transmitting the consumer's information to a potential alternate provider so that the potential alternate provider might determine whether it can offer more favorable terms. Thus, in one web site example, a site operator or someone working with the site operator may have relationships with a host of third party alternate providers. When a consumer enters information about an existing relationship, enabling a determination might comprise providing the information to one or more of those third parties so that one or more may determine if they might offer more favorable terms. Alternatively (or in addition), the site host or other mediator might have a relationship with one or more third parties and might compare the information obtained from the consumer against gathered information so that the third party may make the determination about whether a better offer exists. In this instance, it might be said that the alternate provider is “willing”, even though the alternate offer may be subject to later confirmation by the alternate provider.

Enabling a determination may involve communicating, to one or more providers, consumer information from a plurality of consumers. Based on such information, a provider may seek to develop one or more proposals that tailored to meet the goals of a plurality of such consumers. In other words, based on such information, a provider may be able to bundle a plurality of consumers together, for purposes of generating proposed alternate terms likely to be acceptable to at least a significant portion of such consumers.

Enabling a determination may, alternatively, be conducted through the internal use of the consumer's information, if the party receiving the consumer's information happens to be the offer or of the alternative terms. For example, the host might be an insurance company offering various policies. In such an instance, the insurance company would be able to determine on its own if it is able to offer terms that might be considered more favorable by the consumer. Of course, with a method consistent with the invention, a third party may prompt a consumer to provide information about existing insurance relationships, and the third party may then act as a broker, agent or other intermediary for an alternative provider insurance company.

In another embodiment consistent with the invention, a consolidator or agent may gather information or even negotiate volume rates, and the agent, after having been provided with the consumer's information, might then make a determination that more favorable terms exist. For example, the agent might negotiate volume preferred terms with mortgage companies, wireless phone service providers, internet service providers and others. In such instances, the agent might determine whether a more favorable rate exists, while, for other categories, enabling a determination might involve providing the consumer's information to a party other than the agent.

Enabling a determination may be accomplished with the aid of one or more databases. For example, a database may be provided for purposes of identifying one or more providers and their possible alternate terms based upon information provided by the consumer at step 10. For example, existing terms maybe compared with potential alternate terms in an automated fashion. In this regard, software may identify the relevant terms to be compared, may perform the comparison between existing and potential alternate terms, and may identify possible improved terms. Or the process may be configured to operate with some measure of human intervention.

Where a database of possible alternate terms is utilized as, for example, previously described, enabling a determination may be accomplished by permitting a consumer to query such a database for terms that the consumer would regard as desirable for one reason or another.

In one example of an automated embodiment, a regularly updated database of possible alternate terms for particular consumer relationships may be maintained. For example, a service focusing on wireless telephone agreements may involve a database with a plurality of wireless telephone plans, preferably from a plurality of different wireless service providers, against which a consumer's existing plan can be compared. It may also be desired for the service to utilize the consumer-provided information to “shop” for a better deal for the consumer. (In this regard, the service may wish to bundle together multiple consumers who have provided information at step 10, so as to be able to generate improved bargaining leverage as compared to an individual consumer.)

In another exemplary alternate embodiment of an automated system, an intermediary gathering information from consumers might maintain a computer that communicates with one or more computers maintained by an alternate provider or by an affiliate of an alternate provider.

It should be noted that a consumer may regard alternate terms as more favorable for a variety of possible reasons. Consumers may have different goals in mind with respect to their consumer relationships. For example, one consumer may prefer a lower interest rate loan even if that means a shorter payment term. A different consumer may prefer a longer payment term, even if that means a higher interest rate loan. Some consumers may want a replacement wireless telephone plan, even if it means paying a higher monthly fee, if a sufficiently large number of minutes is provided. There are many possible reasons why different consumers may prefer one set of terms over another. Thus, terms may be considered “more favorable” if it is possible that a consumer may consider them more favorable.

When another provider is willing to provide the consumer with the more favorable first alternate terms, a preferred embodiment of the invention may involve enabling the presentation to the consumer of an offer based on the first alternate terms. As with “prompting”, enabling presentation may occur in many ways, consistent with the invention. For enabling presentation might occur by maintaining an e-mail server or web site configured to include information about the more favorable terms. Thus one who maintains the Internet mechanism, or one who is involved with presenting the information to the Internet mechanism is said, in this example, to “enable presentation” of the offer to the consumer.

The alternative provider, by making available the terms may be said to “enable presentation”. The party who actually transmits the information to the consumer can be said to “enable presentation”. Or by a third party who facilitates the transmission of the alternate offer to the consumer may be said to “enable presentation.” In an Internet-based embodiment of the invention, information about the alternative offer may be conveyed to the consumer through e-mail, or an e-mail notification might advise the consumer that the alternative terms might be reviewed by visiting a website if, or example, for privacy reasons, the consumer may have preferred to remain anonymous, and may have identified his/herself via a nondescript e-mail address. Notification may alternatively be provided by e-mail, phone, post mail, fax, and/or other desired method. it can occur in an automated, semi-automated, or non-automated fashion.

Thus, upon locating possible alternate terms that a particular consumer may deem preferable as compared to existing terms, a method may at step 14 enable the consumer to be notified so that advantage may be taken of such opportunity. For example, the service may notify the consumer that the consumer can refinance his/her mortgage at a lower interest rate, or that a wireless telephone service plan is available with more minutes for a lower monthly fee, or that a credit card company will accept a balance transfer of existing credit card debt at a lower interest rate, etc.

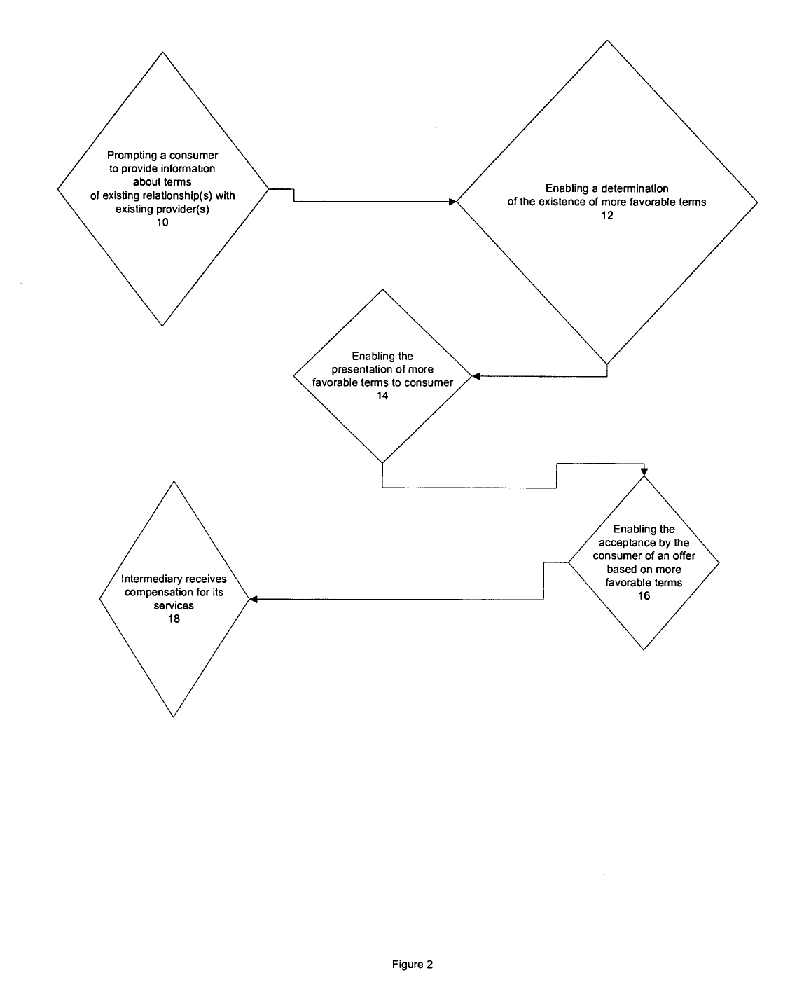

An exemplary embodiment may involve step 16 in FIG. 2, enabling the acceptance by the consumer of the offer based on the first alternate terms. Enabling acceptance may occur by providing a mechanism for the consumer to accept the alternate terms. This could include, providing a mechanism either through e-mail, phone, web site, telephone, post mail, or otherwise for the consumer to articulate an acceptance of the offer. Depending on the mechanism for acceptance that is enabled, the consumer may articulate the acceptance by executing appropriate commands on a web-site, sending a reply e-mail, calling a phone number, mailing a reply card, etc. Alternatively, enabling the acceptance might simply involve providing information about the consumer to a potential alternate provider so that the provider (e.g., a mortgagee, cell phone service provider, etc.) might contact the consumer.

At step 18 in FIG. 2, an intermediary may receive compensation for its services, particularly in the event that a consumer accepts an offer of alternate terms. This is most readily accomplished in those instances where the consumer exercises his/her opportunity utilizing the service web-site. Where an intermediary is involved, to prevent a consumer from circumventing the intermediary's service, the intermediary may choose not to disclose to the consumer the identity of the replacement provider. Or the consumer may be required to utilize a code in communicating to the provider an acceptance of the alternate terms, which code may identify the service as the location of the consumer's receipt of the alternate terms. As a further alternative, the intermediary may communicate with the alternate provider, to inform it that an offer has been communicated to a specific consumer, so that appropriate credit/compensation can be provided if the offer is accepted.

An intermediary may receive compensation for its services from the alternate terms provider. The compensation can be a fixed payment, percentage of actual or anticipated revenues pursuant to a consumer relationship based on the alternate terms, or other value. In addition or as an alternative, a provider may be charged a subscription or other fee to be included in the service's database and thus in possible offers to consumers. The provider may be charged a fee based on receipt of information concerning consumers and their relationships, and/or based on particular offering opportunities presented to the provider.

In addition or in the alternative, the consumer can provide compensation. For example, compensation can be indirectly built into the replacement offer (for example, by the addition of a quarter of a point to an offer of alternate mortgage terms), or it could be directly paid by the consumer. If the consumer pays directly, the consumer, for example, could pay a subscription fee for the service, or pay on a transaction by transaction basis each time a consumer takes advantage of an opportunity generated by the service.

Still further, in addition or in the alternative, it may be desired for a third party that is neither a consumer or a provider to provide compensation hereunder. Such a third party may, for example, have its own subscription or other relationship with consumers, may have financial obligations that are directly or indirectly derivative of the consumers (e.g., a corporation that is responsible for reimbursing an employee for wireless telephone service), is a regulatory body involved in consumer affairs, or is otherwise motivated to expose consumers to alternate offers.

It may sometimes the case that an existing provider is prepared to offer an existing consumer improved terms, when the provider becomes aware that the consumer is interested in making a change. Cell phone providers, in particular, may be willing to negotiate in this fashion. As an additional option, the service can facilitate such re-negotiation, for example by contacting the existing provider and notifying it concerning alternate terms available to the consumer. In such instance, the existing provider may be willing to match the offered terms, to keep the consumer. In this instance, the “alternate provider” may be the same entity as the “existing provider.”

With respect to existing providers, it should be noted that they may wish to participate in one or more of a number of possible ways. An existing provider may wish to be notified that an existing consumer is shopping for a better deal, so that the existing provider can re-negotiate a new relationship with the consumer. The existing provider may desire such information for purposes of measuring the satisfaction of its customers. As with the alternate providers who are not also existing providers, the existing provider may be charged a fee for one or more of receiving the opportunity to review existing terms and propose alternate terms, to receive notification that an existing consumer is shopping for different terms, acceptance by a consumer of new terms, and/or a determination by a consumer following notification from the existing provider to remain in a relationship with the existing provider.

A service web-site may itself be a provider of the services that are to be compared. For example, the service web-site may be that of a wireless telephone service provider, of a bank, etc. However, the service web-site may not necessarily itself be a service provider, since, depending on application, the service web-site may provide offerings from a number of distinct service providers.

Even if presented with a more favorable offer, some consumers might resist making a switch due to logistical impediments. To remove such barriers, an alternate embodiment of the invention may involve facilitating a switch from an existing provider to an alternate provider. Facilitating may include, for example, accepting authorization from the consumer to enable a party other than the consumer to handle at least some of the logistics of changing providers. This may involve one or more of—assisting the consumer in filling out necessary forms, sending appropriate cancellation notices, and placing an order.

While the invention has been particularly shown and described with reference to preferred embodiments thereof, it will be understood by those skilled in the art that the foregoing and other changes in form and details may be made therein without departing from the spirit and scope of the invention. To facilitate an efficient description of exemplary embodiments of the invention, various aspects of varying embodiments have been described together. However, this is not to be construed as a requirement that all such described aspects need necessarily occur together in order to fall within the scope of the invention. Rather, it is the following claims that define the invention, and therefore, the combinations of elements recited in the following claims are incorporated into this detailed description by reference.

1. A method for providing consumers with alternatives to existing consumer relationships, the method comprising:
prompting a consumer to provide information about first existing terms of a first existing relationship between the consumer and a first provider;
prompting the consumer to provide information about second existing terms of a second existing relationship between the consumer and a second provider;
enabling a determination about whether another provider is willing to provide to the consumer first alternate terms that are more favorable than the first existing terms;
enabling a determination about whether another provider is willing to provide to the consumer second alternate terms that are more favorable than the second existing terms;
when another provider is willing to provide the consumer with the more favorable first alternate terms, enabling the presentation to the consumer of an offer based on the first alternate terms; and
when another provider is willing to provide the consumer with the more favorable second alternate terms, enabling the presentation to the consumer of an offer based on the second alternate terms.

2. The method of claim 1 wherein the provider willing to provide first alternate terms differs from the provider willing to provide second alternate terms.

3. The method of claim 1 wherein the provider willing to provide first alternate terms is the same as the provider willing to provide second alternate terms.

4. The method of claim 1, wherein the first existing relationship is in a category unrelated to a category of the second existing relationship.

5. The method of claim 1, wherein the first existing relationship is in a category related to a category of the second existing relationship.

6. The method of claim 1, further comprising prompting the consumer to provide information about the terms of existing relationships with a plurality of additional providers, other than the first and second providers.

7. The method of claim 1 wherein the first existing relationship involves one of a mortgage, car loan, wired or wireless telephone service, data transmission service, credit card service, dry cleaning service, cable or satellite television service, yard service, pool service, Internet service, maid service, snow removal service, magazine subscription, utility, phone service, multi-media delivery, motion picture rentals and broadcasting; advertising opportunities in broadcast and print; waste removal service; landscaping service, video delivery, food delivery; gasoline purchasing; heating oil; transportation service, auto service (maintenance or repair); insurance; service contract on appliances, extended warranty contracts; real estate and automobiles; and
wherein the second existing relationship is a different one of a mortgage, car loan, wired or wireless telephone service, data transmission service, credit card service, dry cleaning service, cable or satellite television service, yard service, pool service, Internet service, maid service, snow removal service, magazine subscription, utility, phone service, multi-media delivery, motion picture rentals and broadcasting; advertising opportunities in broadcast and print; waste removal service; landscaping service, video delivery, food delivery; gasoline purchasing; heating oil; transportation service, auto service (maintenance or repair), insurance; service contract on appliances, extended warranty contracts; real estate and automobiles.

8. The method of claim 1 wherein the steps of enabling a determination occurs in an at least partially automated manner.

9. The method of claim 1 further comprising receiving an acceptance by the consumer of the offer based on the first alternate terms.

10. The method of claim 1 further comprising facilitating a communication between the consumer and an alternate provider so that the consumer may communicate an acceptance of alternate terms to the another provider.

11. The method of claim 1 further comprising receiving consideration from one of the another providers for performing at least one of the steps listed in claim 1.

12. The method of claim 1 further comprising receiving consideration from the consumer for performing at least one of the steps listed in claim 1.

13. The method of claim 1 further comprising negotiating with alternate providers to obtain terms more favorable than existing terms.

14. A method for providing consumers with alternatives to existing consumer relationships, the method comprising:
prompting a consumer to provide information about first existing terms of a first existing relationship between the consumer and a first provider;
wherein the first existing relationship involves one of a mortgage, car loan, wired or wireless telephone service, data transmission service, credit card service, dry cleaning service, cable or satellite television service, yard service, pool service, Internet service, maid service, snow removal service, magazine subscription, utilities, phone service, multi-media delivery, motion picture rentals and broadcasting; advertising opportunities in broadcast and print; waste removal service; landscaping service, video delivery, food delivery; gasoline purchasing; heating oil; transportation service, auto service (maintenance or repair); insurance; service contract on appliances, extended warranty contracts; real estate and automobiles;
prompting the consumer to provide information about second existing terms of a second existing relationship between the consumer and a second provider;
wherein the second existing consumer relationship involves a different one of a involves one of a mortgage, car loan, wired or wireless telephone service, data transmission service, credit card service, dry cleaning service, cable or satellite television service, yard service, pool service, Internet service, maid service, snow removal service, magazine subscription, utilities, phone service, multi-media delivery, motion picture rentals and broadcasting; advertising opportunities in broadcast and print; waste removal service; landscaping service, video delivery, food delivery; gasoline purchasing; heating oil; transportation service, auto service (maintenance or repair), insurance; service contract on appliances, extended warranty contracts; real estate and automobiles;
enabling a determination about whether another provider is willing to provide to the consumer first alternate terms that are more favorable than the first existing terms;
enabling a determination about whether another provider is willing to provide to the consumer second alternate terms that are more favorable than the second existing terms;
when another provider is willing to provide the consumer with the more favorable first alternate terms, enabling the presentation to the consumer of an offer based on the first alternate terms;
when another provider is willing to provide the consumer with the more favorable second alternate terms, enabling the presentation to the consumer of an offer based on the second alternate terms; and
enabling the acceptance by the consumer of the offer based on the first alternate terms.

15. The method of claim 14 further comprising receiving consideration from one of the another providers for performing at least one of the steps listed in claim 13.

16. The method of claim 14 further comprising receiving consideration from the consumer for performing at least one of the steps listed in claim 24.

17. The method of claim 14, further comprising prompting the consumer to provide information about the terms of existing relationships with a plurality of additional providers, other than the first and second existing providers.

18. A method for providing consumers with alternatives to existing consumer relationships, the method comprising:
prompting a consumer to provide information about first existing terms of a first existing relationship between the consumer and a first provider;
wherein the first existing relationship involves one of a mortgage, car loan, wired or wireless telephone service, data transmission service, credit card service, dry cleaning service, cable or satellite television service, yard service, pool service, Internet service, maid service, snow removal service, magazine subscription, utilities, phone service, multi-media delivery, motion picture rentals and broadcasting; advertising opportunities in broadcast and print; waste removal service; landscaping service, video delivery, food delivery; gasoline purchasing; heating oil; transportation service, auto service (maintenance or repair); insurance; service contract on appliances, extended warranty contracts; real estate and automobiles;
prompting the consumer to provide information about second existing terms of a second existing relationship between the consumer and a second provider;
wherein the second existing consumer relationship involves a different one of a mortgage, car loan, wired or wireless telephone service, data transmission service, credit card service, dry cleaning service, cable or satellite television service, yard service, pool service, Internet service, maid service, snow removal service, magazine subscription, utilities, phone service, multi-media delivery, motion picture rentals and broadcasting; advertising opportunities in broadcast and print; waste removal service; landscaping service, video delivery, food delivery; gasoline purchasing; heating oil; transportation service, auto service (maintenance or repair), insurance; service contract on appliances, extended warranty contracts; real estate and automobiles;
enabling at least one potential alternate provider to view at least one of the first existing terms and the second existing terms;
enabling a determination about whether another provider is willing to provide to the consumer first alternate terms that are more favorable than the first existing terms;
enabling a determination about whether another provider is willing to provide to the consumer second alternate terms that are more favorable than the second existing terms;
when another provider is willing to provide the consumer with the more favorable first alternate terms, enabling the presentation to the consumer of an offer based on the first alternate terms;
when another provider is willing to provide the consumer with the more favorable second alternate terms, enabling the presentation to the consumer of an offer based on the second alternate terms; and
enabling the acceptance by the consumer of the offer based on the first alternate terms.

19. The method of claim 18, further comprising prompting the consumer to provide information about the terms of existing relationships with a plurality of additional providers, other than the first and second existing providers.

20. The method of claim 18, further comprising receiving compensation from at least one of the consumer, potential alternate provider, and another providers.
